(19) United States
(12) Patent Application Publication
(10) Pub. No.: US 2005/0067067 A1
(43) Pub. Date: Mar. 31, 2005

(54) Method for producing a metal strip from an iron-nickel alloy for tensioned shadow masks

(75) Inventors: Bodo Gehrmann, Plettenberg (DE); Janine Lindemann, Duesseldorf (DE)

Correspondence Address: JORDAN AND HAMBURG LLP, 122 EAST 42ND STREET, SUITE 4000, NEW YORK, NY, 10168, US

(73) Assignee: Thyssenkrupp VDM GmbH, Werdohl (DE)

(21) Appl. No.: 10/489,834

(22) PCT Filed: Aug. 2, 2002
(86) PCT No.: PCT/EP02/08610

(30) Foreign Application Priority Data
Sep. 19, 2001 (DE) 101 46 301.4

(51) Int. Cl. C21D 8/02

(52) U.S. Cl. 148/621

(57) ABSTRACT

A method for producing iron-nickel alloy strip for tensioned shadow masks for use in flat monitors and screens, includes the steps of forming an alloy having a composition, in mass %, of 35-38% Ni, 0.4-0.8% Mo, 0.1-0.3% Cr, 0.08-0.12% C, up to 1% Mn, up to 1% Si, up to 1% Nb, with the balance to total 100% being Fe and impurities; cold rolling the alloy composition to a predetermined final thickness to form a strip;
and annealing the cold-rolled strip at predetermined temperatures over a range wherein a coercive field strength (H_{c}) of the alloy strip first decreases to a minimum value and then remains substantially constant as annealing temperature is increased; such that the annealed strip has a coercive field strength<100 A/m and a creep strain<0.1% at conditions of 460° C., and a load of 138 mPa, for 1 hour.

The invention relates to a method for producing a metal strip from an iron-nickel alloy for tensioned shadow masks for use in flat monitors and screens.

Iron-based alloys with approximately 36% nickel have been used for a number of years for molded shadow masks in monitors and television equipment because of their low coefficient of thermal expansion between 20 and 100° C. Technical iron-nickel alloys with approximately 36% nickel, as are prevalent in conventional screen tubes, in the soft-annealed condition in the temperature range of 20 to 100° C. have a coefficient of thermal expansion between 1.2 and 1.8×10⁻⁶/K, as characterized in the Steel-Iron Material Data Page (SEW-385, 1991 edition).

For molded shadow masks, further developed materials with approximately 36% nickel are also in use that achieve lower coefficients of thermal expansion between 0.6 and 1.2×10⁻¹/k in the temperature range of 20 to 100° C.

With the development of ever larger and especially flat screens, in addition to the technology of molded shadow masks, manufacturers of screen tubes also conduct research and development in the field of tensioned shadow masks. In such cases, the shadow masks, which are etched from a thin iron-nickel film with approximately 36% nickel, are affixed to a massive metal frame with a welding method such that they are maintained under tension and thus in shape. The combination of frame and shadow mask is subjected to a thermal treatment in which an oxide layer is created that is advantageous for color picture tubes. The strips used in the past for tensioned shadow masks are produced in a cold-rolling process to the final thickness. The consequence of this is that the shadow masks produced from this have a high magnetic coercive field strength Hc. In the previous method, therefore, the screen tube manufacturer had to select the temperature for the thermal treatment relatively high so that the magnetic coercive field strength Hc is reduced to a relatively small value by approximately 400 A/m and the necessary effect is achieved for shielding the electron beams from the interfering effect of the ground magnetic field. It has now been demonstrated that thermal treatment while utilizing a temperature that has been selected on the high side, in the range of between approximately 550 and 650° C., under a load that acts on the tensioned shadow mask, results in a relatively large creep strain of for instance approximately 0.6% at a test load of 138 mPa. This can have as its consequence that the shadow mask, after its thermal treatment following cooling, loses tension and thus loses the required mechanical stability and shape. In addition, this problem can be compounded in that for very large screens the surface of the shadow mask is also very large. It has been demonstrated that the magnetic coercive field strength Hc in very large shadow masks must be substantially less than 400 A/m so that the paths of the electron beams are effectively shielded against interference by the ground magnetic field.

DE-A 199 44 578 describes one iron-nickel alloy that includes contents (in mass %) of Ni of 35 to 38%, Mo of 0.4 to 0.8%, Cr of 0.1 to 0.3%, C of 0.08 to 0.12%, Mn up to a maximum 1%, Si up to a maximum 1%, and Nb up to a max. 1%. This alloy has a coefficient of thermal expansion of approximately 1.5×10⁻⁶/K between 20 and 100° C.

The object of the present invention is therefore to provide an alternative method with which, using a suitable iron-nickel alloy of sufficiently low thermal expansion, tensioned shadow masks can achieve both a substantially lower coercive field strength and a substantially lower creep strain.

This object is attained using a method for producing a strip made of an iron-nickel alloy for tensioned shadow masks for use in flat monitors and screens, whereby the strip, comprising a chemical composition (in mass %) of 35-38% Ni, 0.4-0.8% Mo, 0.1-0.3% Cr, 0.08-0.12% C, max. 1% Mn, max. 1% Si, max 1% Nb, and the balance Fe and production-related impurities, after a cold-rolling process to a final thickness, is subjected to continuous annealing or batch annealing in a presettable temperature range at which the coercive field strength Hc assumes the lowest value after its steep decrease and remains largely unchanged when the annealing temperature is increased.

The alloy cited in the prior art in accordance with DE-A 199 44 578 is suitable for being processed with the inventive method in order to attain the desired parameters. Compared to the general state of the art, an alternative production method is provided with which for producing tensioned shadow masks coercive field strengths<100 A/m and a creep strain<0.1% are attainable at presettable test conditions, such as for instance 1 hour and at 460° C. and at a load of 138 mPa.

The technological properties that are furthermore required for the application as a strip for a tensioned shadow mask can in particular be obtained with this iron-nickel alloy with the inventive production method.

The described iron-nickel alloy is melted in an arc furnace and cast in the shape of ingots. After the hot-rolling processes from ingot to slab and from slab to hot strip with a thickness of approximately 4.0 mm, it is finished to a cold strip with the desired final thickness in a plurality of cold-rolling processes and thermal treatments performed therebetween in the continuous annealing process. Up to this condition the production method corresponds to the prior art.

In this cold-worked condition, the coercive field strength Hc is approximately 600 A/m, which can only be reduced to approximately 400 A/m on the shadow mask tensioned on the frame with black-annealing without the shadow mask losing its tension during this black-annealing process.

The inventive production method starts at the cold-rolled condition of the strip of the iron-nickel alloy. The strip of the iron-nickel alloy that has been rolled to the final thickness is subjected, prior to the etching process on the shadow mask, to a thermal treatment either in the continuous annealing furnace or in a bell furnace. The temperature range or the temperature is used at which the coercive field strength Hc assumes the exact lowest value after its steep decrease and would remain nearly unchanged if the annealing temperature is increased. Preferably a temperature range of 750-850° C. is used.

In the case of the described iron-nickel alloy, but also in other iron-nickel alloys, in the prior art coercive field strengths of less than approximately 100 A/m are achievable after such an annealing treatment.

In addition to depending on the residence time, the optimum annealing temperature depends both on the chemical composition of the iron-nickel alloy used and also on the last cold-forming degree used prior to the annealing treatment.

Surprisingly, the inventively annealed strip of the described iron-nickel alloy under test conditions of 1 hour at 460° C. with a load of 138 mPa, which corresponds to a simulation of sufficient black-annealing of a shadow mask tensioned on a frame, obtains a very low creep strain<0.1%. An additional process step that is necessary in certain circumstances for improving planeness increases the coercive field strength only slightly so that a value less than 200 A/m is maintained.

Herewith a production method is provided that makes possible the production of a strip made of an iron-nickel alloy for tensioned shadow masks that can be employed in large-format flat screens. It offers substantial advantages to manufacturers of screen tubes because with this production method a smaller coercive field strength, and thus better magnetic behavior, can be set even prior to the etching process for shadow mask production, than was not possible in the past [sic], even using a special thermal treatment in conjunction with frame and tensioned shadow mask at a higher temperature. This leads, first, in terms of technology, to better properties, but also to certain and more simple tube production, since no additional thermal treatment is necessary in addition to the conventional thermal treatments in the further process chain.

An iron-nickel alloy with the exemplary chemical composition (in mass %) of 0.087% C, 0.0008% S, 0.001% N, 0.18% Cr, 36.40% Ni, 0.14% Mn, 0.10% Si, 0.62% Mo, 0.01% Ti, 0.05% Nb, 0.01% Cu, 0.002% P, 0.001% Al, <0.001% Mg, 0.01% Co, and the balance iron, was formed into strip that was rolled to the thickness 0.10 mm with a forming degree of 50% and was annealed in the continuous annealing furnace with a residence time of 45 s at 800° C., a coercive field strength Hc of 72 A/m and a creep strain of 0.037% at test conditions of 1 hour at 460° C. and a load of 138 mPa.

The production method for obtaining very small magnetic coercive field strengths with improved creep strength can also be applied to strip material made of iron-nickel alloys for tensioned shadow masks whose chemical compositions correspond to the prior art. One skilled in the art will adapt the appropriate analysis to the application.

The desired properties are advantageously achieved when the annealing occurs in the range of the recrystallization temperature. The recrystallization temperature (over [sic] better, the temperature at which the exact lowest Hc value is obtained) depends on the forming degree and on the residence time. The necessary annealing time depends on the annealing temperature or vice versa, that is, there can be different parameter sets with different materials in order to reach the objective. In general, a temperature range between 600 and 1100° C. and a residence time of 10 seconds to 4 hours can be used.

One further embodiment of the inventive production method provides that the strip of iron-nickel alloy is thermally treated under tension in the continuous annealing oven or is annealed in a bell furnace as a coil wound under tension. This forestalls mechanical creep as early as during the production method and thus clearly reduces the remaining creep strain that would be released during the later thermal treatment under load.

The inventive method makes it possible to forestall mechanical creep as early as during the production method and thus to reduce the remaining creep strain that would be released during the subsequent thermal treatment in that the strip of an iron-nickel alloy is thermally treated under tension in the continuous annealing oven or is annealed in the bell furnace as a coil wound under tension.

1-6. (Canceled)

7. Method for producing iron-nickel alloy strip for tensioned shadow masks for use in flat monitors and screens, comprising:
a.) forming an alloy composition comprising, in mass %, 35-38% Ni, 0.4-0.8% Mo, 0.1-0.3% Cr, 0.08-0.12% C, up to 1% Mn, up to 1% Si, up to 1% Nb, and balance to total 100% Fe and production—related impurities;
b.) cold rolling said composition to a predetermined final thickness to form a strip; and
c.) annealing said cold-rolled strip at predetermined temperatures over a range wherein a coercive field strength (H_{c}) of said strip first decreases to a minimum value and then remains substantially constant as annealing temperature is increased;
such that annealed strip has a coercive field strength<100 A/m and a creep strain<0.1% at conditions of 460° C., and a load of 138 mPa, for 1 hour.

8. Method according to claim 7, wherein said annealing is performed alternatively as continuous annealing and batch annealing.

9. Method according to claim 8, wherein said annealing is continuous and is performed while said strip is under tensile stress.

10. Method according claim 7, wherein said annealing is performed in a bell furnace, while said strip is in a wound state under tensile stress.

11. Method according to claim 7, wherein said annealing is performed at a temperature of 600-1100° C. for a time of 10 seconds to 4 hours.
